(19) United States
(12) Patent Application Publication
(10) Pub. No.: US 2019/0062624 A1
(43) Pub. Date: Feb. 28, 2019

(54) PHOTOCHROMIC OPHTHALMIC LENS AND METHOD FOR MAKING THE SAME

(71) Applicant: HON HAI PRECISION INDUSTRY CO., LTD., New Taipei (TW)

(72) Inventor: HSIU-WEN CHIEN, New Taipei (TW)

(21) Appl. No.: 15/686,236

(22) Filed: Aug. 25, 2017

(30) Foreign Application Priority Data
Aug. 22, 2017 (TW) 106128481

(51) Int. Cl. C09K 9/02; G02B 1/04; C08L 33/14; C08L 43/04; B29D 11/00

(52) U.S. Cl. CPC C09K 9/02; G02B 1/041; C08L 33/14; B29K 2105/0061; B29D 11/00038; C09K 2211/145; C09K 2211/1018; C08L 43/04

(57) ABSTRACT

A photochromic ophthalmic lens includes a body and photochromic molecule-cyclodextrin inclusion compounds dispersed in the body. The photochromic molecule-cyclodextrin inclusion compounds include cyclodextrins and photochromic molecules entrapped in a cavity of the cyclodextrins. Notwithstanding the hydrophobic nature of the photochromic molecules, the cyclodextrins, which contains cavities entrapping the photochromic molecules, are hydrophilic.

### FIELD

The subject matter herein generally relates to ophthalmic lenses, and more particularly, to a photochromic ophthalmic lens and a method for making the photochromic ophthalmic lens.

### BACKGROUND

Photochromic molecules can undergo a reversible change of color upon exposure to certain wavelengths of light. Photochromic molecules can be applied in the manufacture of photochromic ophthalmic lenses. However, the photochromic molecules are usually hydrophobic and cannot be dissolved in a hydrophilic solvent, which may limit their use in the photochromic ophthalmic lenses.

### BRIEF DESCRIPTION OF THE DRAWINGS

Implementations of the present technology will now be described, by way of example only, with reference to the attached figures.

FIG. 1 is a flowchart of an exemplary embodiment of a method for making a photochromic ophthalmic lens.

FIG. 2 is a diagram of an exemplary embodiment of a photochromic ophthalmic lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

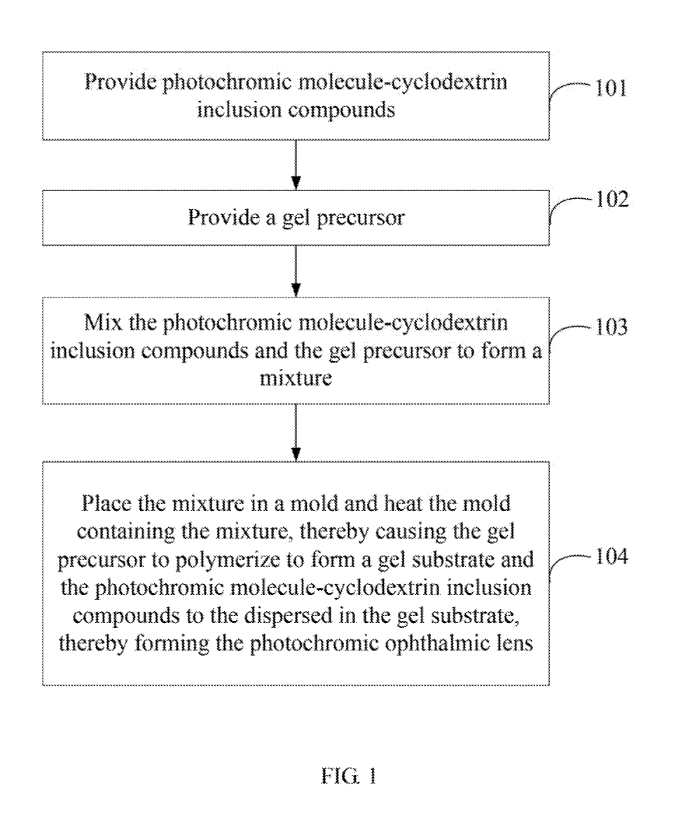

FIG. 1 illustrates a flowchart of an embodiment for a method for making a photochromic ophthalmic lens. The exemplary method is provided by way of example, as there are a variety of ways to carry out the method. Each block shown in the figure represents one or more processes, methods, or subroutines, carried out in the exemplary method. Furthermore, the illustrated order of blocks is by example only, and the order of the blocks can change. Additional blocks may be added or fewer blocks may be utilized, without departing from this disclosure. The exemplary method can begin at block 101.

At block 101, photochromic molecule-cyclodextrin inclusion compounds are provided.

The photochromic molecule-cyclodextrin inclusion compounds comprise cyclodextrins and photochromic molecules entrapped in a cavity of the cyclodextrins. The cyclodextrins are hydrophobic inside the cavity, and thus able to host other hydrophobic molecules such as photochromic molecules. However, the cyclodextrins are externally hydrophilic. Thus, the formation of the photochromic molecule-cyclodextrin inclusion compounds can modify the water solubility of the photochromic molecules, without affecting the photochromic properties of the photochromic molecules.

In at least one exemplary embodiment, the photochromic molecules can be selected from a group consisting of spiropyrans, spiroperimidines, diarylethenes, fulgides, hexaarylbiimidazole, azobenzenes, benzopyrylospiran, and any combination thereof.

In at least one exemplary embodiment, the cyclodextrins are cyclodextrin derivatives formed by modifying cyclodextrins by methacrylates. The cyclodextrin derivatives have methacrylate groups, and have a chemical diagram of

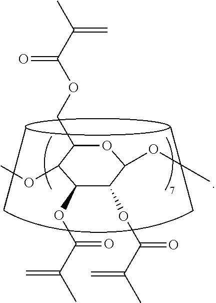

In at least one exemplary embodiment, the formation of the photochromic molecule-cyclodextrin inclusion compounds can be carried out by adding the photochromic molecules in ethanol, tetrahydrofuran, or acetone to form a photochromic solution. The cyclodextrins are added in water to form a cyclodextrin solution. The photochromic solution and the cyclodextrin solution are mixed to form a mixed solution. The mixed solution is stirred to cause the photochromic molecules to be entrapped in the cavity of the cyclodextrins, thereby forming the photochromic molecule-cyclodextrin inclusion compounds. Finally, the photochromic molecule-cyclodextrin inclusion compounds are separated from the mixed solution. In at least one exemplary embodiment, the photochromic molecules have a concentration of about 0.0001 mol/L to about 0.1 mol/L in the photochromic solution. The cyclodextrins have a concentration of about 0.0001 mol/L to about 0.1 mol/L in the cyclodextrin solution.

At block 102, a hydrogel precursor is provided that comprises hydrophilic monomers, a cross-linking agent, and an initiator.

In at least one exemplary embodiment, the hydrophilic monomers can be selected from a group consisting of 2-hydroxyethyl methacrylate (HEMA), N,N′-dimethylacrylamide (DMA), methyl methacrylate (MMA), N-vinyl pyrrolidone (NVP), polyethylene glycol maleate (PEGMA), 3-[tris(trimethylsilyl)silyl]propylmethacrylate (TRIS), polydimethylsiloxane (PDMS), hydroxyethyl acrylate (HEA), hydroxypropyl methacrylate (HPMA), dimethylaminoethyl methacrylate (DMAEMA), methyl acrylate (MA), and any combination thereof.

The cross-linking agent can be selected from a group consisting of ethylene glycol dimethacrylate (EGDMA), trimethylolpropane trimethacrylate (TMPTMA), N,N′-methylenediacrylamide (MBAA), and any combination thereof.

The initiator may be a thermal initiator. The thermal initiator may be selected from a group consisting of 2,2′-azobis (2,4-dimethylpentanenitrile), 2,2′-azobis (2-methylpropanenitrile), 2,2′-azobis (2-methylbutanenitrile), azobisisobutyronite (AIBN), peroxides (such as benzoyl peroxide), and any combination thereof.

At block 103, the photochromic molecule-cyclodextrin inclusion compounds and the gel precursor are mixed to form a mixture.

The hydrophilic monomers have a mass percentage of about 56% to about 99.82% of a total mass of the mixture. The cross-linking agent has a mass percentage of about 0.03% to about 21.82% of the total mass of the mixture. The initiator has a mass percentage of about 0.042% to about 18.62% of the total mass of the mixture. The initiator has a mass percentage of about 0.042% to about 18.62% of the total mass of the mixture. The photochromic molecule-cyclodextrin inclusion compounds have a mass percentage of about 0.08% to about 15.37% of the total mass of the mixture.

In at least one exemplary embodiment, the mixture can further comprise a solvent. The solvent can be a hydrophilic solvent. In at least one exemplary embodiment, the solvent is alcohol or a mixed solution comprising water and alcohol. For example, the solvent can be ethanol.

At block 104, the mixture is placed in a mold, and the mold containing the mixture is heated, thereby causing the gel precursor to polymerize to form a gel substrate and the photochromic molecule-cyclodextrin inclusion compounds to the dispersed in the gel substrate. Thus, the photochromic ophthalmic lens is formed.

In at least one exemplary embodiment, an inside of the mold containing the mixture is heated to about 60 degrees Celsius to about 90 degrees Celsius, for about 0.5 hours to about 5 hours.

When the cyclodextrins are cyclodextrin derivatives having methacrylate groups, the methacrylate groups of the cyclodextrin derivatives can also react with the components of the gel precursor when heated, to form covalent bonds.

### EXAMPLE 1

A photochromic solution of 100 L was formed in which spiropyrans had a concentration of 0.01 mol/L. A cyclodextrin solution of 100 L was formed in which cyclodextrin had a concentration of 0.01 mol/L. The photochromic solution and the cyclodextrin solution were mixed to form photochromic molecule-cyclodextrin inclusion compounds. HEMA, EGDMA, AIBN, and the photochromic molecule-cyclodextrin inclusion compounds were mixed to form a mixture. The HEMA had a mass percentage of 97.515% of a total mass of the mixture, the EGDMA had a mass percentage of 0.045% of the total mass of the mixture, the AIBN had a mass percentage of 0.12% of the total mass of the mixture, and photochromic molecule-cyclodextrin inclusion compounds had a mass percentage of 2.32% of the total mass of the mixture. The mixture was placed in mold and heated to 70 degrees Celsius for 2 hours to form the photochromic ophthalmic lens 100.

### EXAMPLE 2

A photochromic solution of 100 L was formed in which spiroperimidines had a concentration of 0.01 mol/L. A cyclodextrin solution of 100 L was formed in which cyclodextrin had a concentration of 0.01 mol/L. The photochromic solution and the cyclodextrin solution were mixed to form photochromic molecule-cyclodextrin inclusion compounds. HEMA, NVP, TRIPS, EGDMA, AIBN, ethanol, and the photochromic molecule-cyclodextrin inclusion compounds were mixed to form a mixture. The HEMA had a mass percentage of 9.18% of a total mass of the mixture, the NVP had a mass percentage of 23.12% of the total mass of the mixture, the TRIPS had a mass percentage of 31.21% of the total mass of the mixture, the EGDMA had a mass percentage of 0.045% of the total mass of the mixture, the AIBN had a mass percentage of 0.12% of the total mass of the mixture, the ethanol had a mass percentage of 31.085% of the total mass of the mixture, and photochromic molecule-cyclodextrin inclusion compounds had a mass percentage of 5.24% of the total mass of the mixture. The mixture was placed in mold and heated to 65 degrees Celsius for 4 hours to form the photochromic ophthalmic lens 100.

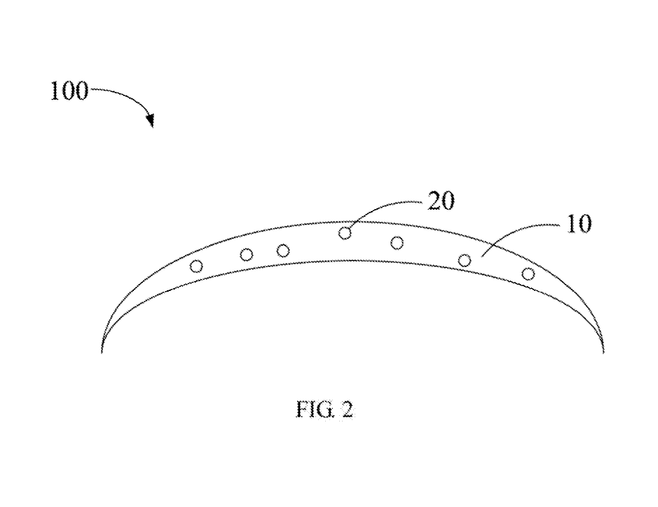

FIG. 2 illustrates an exemplary embodiment of a photochromic ophthalmic lens 100. The photochromic ophthalmic lens 100 can be spectacle glass having a photochromic function. The photochromic ophthalmic lens 100 comprises an ophthalmic lens body 10 and photochromic molecule-cyclodextrin inclusion compounds 20 dispersed in the ophthalmic lens body 10.

In at least one exemplary embodiment, the photochromic molecule-cyclodextrin inclusion compounds 20 have a mass percentage of about 0.08% to about 15.37% of a total mass of the photochromic ophthalmic lens 100.

With the above configuration, the formation of the photochromic molecule-cyclodextrin inclusion compounds modifies the water solubility of the photochromic molecules without affecting the photochromic properties of the photochromic molecules. Such photochromic molecules may be used in photochromic ophthalmic lens.

Depending on the embodiment, certain of the steps of methods hereinbefore described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for making a photochromic ophthalmic lens comprising:
providing photochromic molecule-cyclodextrin inclusion compounds and a gel precursor, the photochromic molecule-cyclodextrin inclusion compounds comprising cyclodextrins and photochromic molecules entrapped in a cavity of the cyclodextrins;
mixing the photochromic molecule-cyclodextrin inclusion compounds and the gel precursor to form a mixture; and
placing the mixture in a mold and heating the mold containing the mixture, thereby causing the gel precursor to polymerize to form a gel substrate and the photochromic molecule-cyclodextrin inclusion compounds to the dispersed in the gel substrate, thereby forming the photochromic ophthalmic lens.

2. The method of claim 1, wherein the photochromic molecules are selected from a group consisting of spiropyrans, spiroperimidines, diarylethenes, fulgides, hexaarylbiimidazole, azobenzenes, benzopyrylospiran, and any combination thereof.

3. The method of claim 1, wherein the cyclodextrins are cyclodextrin derivatives having methacrylate groups.

4. The method of claim 1, wherein the hydrogel precursor comprises hydrophilic monomers, a cross-linking agent, and an initiator.

5. The method of claim 4, wherein the hydrophilic monomers are selected from a group consisting of 2-hydroxyethyl methacrylate, N,N′-dimethylacrylamide, methyl methacrylate, N-vinyl pyrrolidone, polyethylene glycol maleate, 3-[tris(trimethyl silyl)silyl]propylmethacrylate, polydimethyl siloxane, hydroxyethyl acrylate, hydroxypropyl methacrylate, dimethylaminoethyl methacrylate, methyl acrylate, and any combination thereof.

6. The method of claim 4, wherein the cross-linking agent is selected from a group consisting of ethylene glycol dimethacrylate, trimethylolpropane trimethacrylate, N,N′-methylenediacrylamide, and any combination thereof.

7. The method of claim 4, wherein the initiator is selected from a group consisting of 2,2′-azobis (2,4-dimethylpentanenitrile), 2,2′-azobis (2-methylpropanenitrile), 2,2′-azobis (2-methylbutanenitrile), azobisisobutyronite, peroxides, and any combination thereof.

8. The method of claim 4, wherein the hydrophilic monomers have a mass percentage of about 56% to about 99.82% of a total mass of the mixture, the cross-linking agent has a mass percentage of about 0.03% to about 21.82% of the total mass of the mixture, the initiator has a mass percentage of about 0.042% to about 18.62% of the total mass of the mixture, the initiator has a mass percentage of about 0.042% to about 18.62% of the total mass of the mixture, and the photochromic molecule-cyclodextrin inclusion compounds have a mass percentage of about 0.08% to about 15.37% of the total mass of the mixture.

9. The method of claim 1, wherein the mixture further comprises a solvent.

10. The method of claim 1, wherein the solvent is alcohol or a mixed solution comprising water and alcohol.

11. The method of claim 1, wherein the photochromic molecule-cyclodextrin inclusion compounds are prepared by:
adding the photochromic molecules in ethanol, tetrahydrofuran, or acetone to form a photochromic solution;
adding the cyclodextrins in water to form a cyclodextrin solution;
mixing the photochromic solution and the cyclodextrin solution to form a mixed solution;
stirring the mixed solution to cause the photochromic molecules to be entrapped in the cavity of the cyclodextrins, thereby forming the photochromic molecule-cyclodextrin inclusion compounds; and
separating the photochromic molecule-cyclodextrin inclusion compounds from the mixed solution.

12. The method of claim 11, wherein the photochromic molecules have a concentration of about 0.0001 mol/L to about 0.1 mol/L in the photochromic solution, and the cyclodextrins have a concentration of about 0.0001 mol/L to about 0.1 mol/L in the cyclodextrin solution.

13. A photochromic ophthalmic lens comprising:
an ophthalmic lens body; and
photochromic molecule-cyclodextrin inclusion compounds dispersed in the ophthalmic lens body, the photochromic molecule-cyclodextrin inclusion compounds comprising cyclodextrins and photochromic molecules entrapped in a cavity of the cyclodextrins.

14. The photochromic ophthalmic lens of claim 13, wherein the photochromic molecule-cyclodextrin inclusion compounds have a mass percentage of about 0.08% to about 15.37% of a total mass of the photochromic ophthalmic lens.

15. The photochromic ophthalmic lens of claim 13, wherein the cyclodextrins are cyclodextrin derivatives having methacrylate groups.

16. The photochromic ophthalmic lens of claim 13, wherein the photochromic molecules are selected from a group consisting of spiropyrans, spiroperimidines, diarylethenes, fulgides, hexaarylbiimidazole, azobenzenes, benzopyrylospiran, and any combination thereof.
